(19) United States
(12) Patent Application Publication
(10) Pub. No.: US 2016/0140042 A1
(43) Pub. Date: May 19, 2016

(54) INSTRUCTION CACHE TRANSLATION MANAGEMENT

(71) Applicant: Cavium, Inc., San Jose, CA (US)

(72) Inventor: Shubhendu Sekhar Mukherjee, Southborough, MA (US)

(21) Appl. No.: 14/541,826

(22) Filed: Nov. 14, 2014

(51) Int. Cl. G06F 12/08

(52) U.S. Cl. CPC G06F 12/0875; G06F 12/0811; G06F 2212/283; G06F 2212/452

(57) ABSTRACT

Managing an instruction cache of a processing element, the instruction cache including a plurality of instruction cache entries, each entry including a mapping of a virtual memory address to one or more processor instructions, includes: issuing, at the processing element, a translation lookaside buffer invalidation instruction for invalidating a translation lookaside buffer entry in a translation lookaside buffer, the translation lookaside buffer entry including a mapping from a range of virtual memory addresses to a range of physical memory addresses; causing invalidation of one or more of the instruction cache entries of the plurality of instruction cache entries in response to the translation lookaside buffer invalidation instruction.

### BACKGROUND

This invention relates to management of memory address translation in computing systems.

Many computing systems utilize virtual memory systems to allow programmers to access memory addresses without having to account for where the memory addresses reside in the physical memory hierarchies of the computing systems. To do so, virtual memory systems maintain a mapping of virtual memory addresses, which are used by the programmer, to physical memory addresses that store the actual data referenced by the virtual memory addresses. The physical memory addresses can reside in any type of storage device (e.g., SRAM, DRAM, magnetic disk, etc.).

When a program accesses a virtual memory address, the virtual memory system performs an address translation to determine which physical memory address is referenced by the virtual memory address. The data stored at the determined physical memory address is read from the physical memory address, as an offset within a memory page, and returned for use by the program. The virtual-to-physical address mappings are stored in a “page table.” In some cases, the virtual memory address be located in a page of a large virtual address space that translates to a page of physical memory that is not currently resident in main memory (i.e., a page fault), so that page is then copied into main memory.

Modern computing systems include one or more translation lookaside buffers (TLBs) which are caches for the page table, used by the virtual memory system to improve the speed of virtual to physical memory address translation. Very generally, a TLB includes a number of entries from the page table, each entry including a mapping from a virtual address to a physical address. Each TLB entry may directly cache a page table entry or may combine several entries in the page table in such a way that it produces a translation from a virtual address to a physical address. In general, the entries of the TLB cover only a portion of the total memory available to the computing system. In some examples, the entries of the TLB are maintained such that the portion of the total available memory covered by the TLB includes the most recently accessed, most commonly accessed, or most likely to be accessed portion of the total available memory. In general, the entries of a TLB need to be managed whenever the virtual memory system changes the mappings between virtual memory addresses and physical memory addresses.

In some examples, other elements of computing systems, such as the instruction caches of the processing elements, include entries that are based on the mappings between virtual memory addresses and physical memory addresses. These elements also need to be managed whenever the virtual memory system changes the mappings between virtual memory addresses and physical memory addresses.

### SUMMARY

In one aspect, in general, a method for managing an instruction cache of a processing element, the instruction cache including a plurality of instruction cache entries, each entry including a mapping of a virtual memory address to one or more processor instructions, includes: issuing, at the processing element, a translation lookaside buffer invalidation instruction for invalidating a translation lookaside buffer entry in a translation lookaside buffer, the translation lookaside buffer entry including a mapping from a range of virtual memory addresses to a range of physical memory addresses; causing invalidation of one or more of the instruction cache entries of the plurality of instruction cache entries in response to the translation lookaside buffer invalidation instruction.

Aspects can include one or more of the following features.

The method further includes determining the one or more instruction cache entries of the plurality of instruction cache entries including identifying instruction cache entries that include a mapping having a virtual memory address in the range of virtual memory addresses, wherein causing invalidation of one or more of the instruction cache entries includes invalidating each instruction cache entry of the one or more instruction cache entries.

Each instruction cache entry includes a virtual address tag and determining the one or more instruction cache entries includes, for each instruction cache entry of the plurality of instruction cache entries, comparing the virtual address tag of the instruction cache entry to the range of virtual memory addresses.

Comparing the virtual address tag of the instruction cache entry to the range of virtual memory addresses includes comparing the virtual address tag of the instruction cache entry to a portion of virtual memory addresses in the range of virtual memory addresses.

The portion of the virtual memory addresses includes a virtual page number of the virtual memory addresses.

Causing invalidation of one or more of the instruction cache entries includes causing, at the processing element, an instruction cache entry invalidation operation.

The instruction cache entry invalidation operation is a hardware triggered operation.

The translation lookaside buffer invalidation instruction is a software triggered instruction.

Causing invalidation of one or more of the instruction cache entries includes causing invalidation of an entirety of each of the one or more instruction cache entries.

Causing invalidation of one or more of the instruction cache entries includes causing invalidation of all processor instructions associated with the one or more instruction cache entries.

Causing invalidation of one or more of the instruction cache entries includes causing invalidation of a single processor instruction associated with the one or more instruction cache entries.

Causing invalidation of one or more of the instruction cache entries includes causing invalidation of all of the instruction cache entries of the plurality of instruction cache entries.

In another aspect, in general, an apparatus includes: at least one processing element, including: an instruction cache including a plurality of instruction cache entries, each entry including a mapping of a virtual memory address to one or more processor instructions, and a translation lookaside buffer including a plurality of translation lookaside buffer entries, each entry including a mapping from a range of virtual memory addresses to a range of physical memory addresses. The processing element is configured to issue a translation lookaside buffer invalidation instruction for invalidating a translation lookaside buffer entry in the translation lookaside buffer; and the processing element is configured to cause invalidation of one or more of the instruction cache entries of the plurality of instruction cache entries in response to the translation lookaside buffer invalidation instruction.

Aspects can include one or more of the following features.

The processing element is configured to determine the one or more instruction cache entries of the plurality of instruction cache entries including identifying instruction cache entries that include a mapping having a virtual memory address in the range of virtual memory addresses, wherein causing invalidation of one or more of the instruction cache entries includes invalidating each instruction cache entry of the one or more instruction cache entries.

Each instruction cache entry includes a virtual address tag and determining the one or more instruction cache entries includes, for each instruction cache entry of the plurality of instruction cache entries, comparing the virtual address tag of the instruction cache entry to the range of virtual memory addresses.

Comparing the virtual address tag of the instruction cache entry to the range of virtual memory addresses includes comparing the virtual address tag of the instruction cache entry to a portion of virtual memory addresses in the range of virtual memory addresses.

The portion of the virtual memory addresses includes a virtual page number of the virtual memory addresses.

Causing invalidation of one or more of the instruction cache entries includes causing, at the processing element, an instruction cache entry invalidation operation.

The instruction cache entry invalidation operation is a hardware triggered operation.

The translation lookaside buffer invalidation instruction is a software triggered instruction.

Causing invalidation of one or more of the instruction cache entries includes causing invalidation of an entirety of each of the one or more instruction cache entries.

Causing invalidation of one or more of the instruction cache entries includes causing invalidation of all processor instructions associated with the one or more instruction cache entries.

Causing invalidation of one or more of the instruction cache entries includes causing invalidation of a single processor instruction associated with the one or more instruction cache entries.

Causing invalidation of one or more of the instruction cache entries includes causing invalidation of all of the instruction cache entries of the plurality of instruction cache entries.

Aspects can have one or more of the following advantages.

Among other advantages, aspects obviate the need to send one or more software instructions for invalidating entries in the instruction cache when performing translation management.

By using a virtually indexed, virtually tagged instruction cache, performance is improved since translation of virtual memory addresses to physical memory addresses is not required to access the instruction cache.

Other features and advantages of the invention will become apparent from the following description, and from the claims.

### DESCRIPTION OF DRAWINGS

FIG. 1 is a computing system.

FIG. 2 is a processing element coupled to a processor bus.

FIG. 3 is a virtually indexed, virtually tagged set associative instruction cache.

FIG. 4 shows a first step for accessing an instruction in the instruction cache.

FIG. 5 shows a second step for accessing the instruction in the instruction cache.

FIG. 6 shows a third step for accessing the instruction in the instruction cache.

FIG. 7 is a translation lookaside buffer.

FIG. 8 shows a first step for accessing a mapping in the translation lookaside buffer.

FIG. 9 shows a second step for accessing the mapping in the translation lookaside buffer.

FIG. 10 shows an instruction translation lookaside buffer receiving a translation lookaside buffer invalidation instruction for a virtual memory address.

FIG. 11 shows the instruction translation lookaside buffer invalidating the virtual memory address.

FIG. 12 shows the translation lookaside buffer causing invalidation of the virtual memory address in the instruction cache.

FIG. 13 shows a first step for invalidating instructions associated with the virtual memory address in the instruction cache.

FIG. 14 shows a second step for invalidating instructions associated with the virtual memory address in the instruction cache.

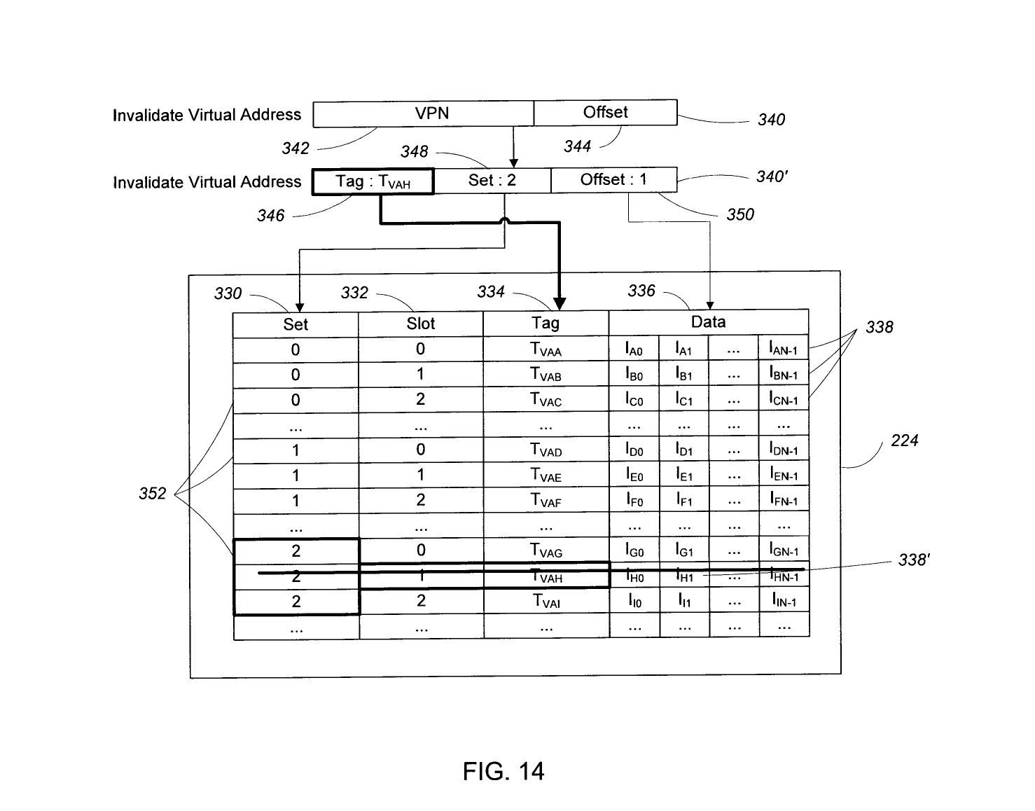

### DESCRIPTION

### 1 Overview

Some computing systems implement instruction caches in processing elements as virtually indexed, virtually tagged (VIVT) caches. Doing so can be beneficial to the performance of the computing systems. For example, since processor cores operate using virtual memory addresses, no translation from a virtual memory address to a physical memory address is required to search the instruction cache. Performance can be significantly improved by avoiding such a translation.

However, VIVT caches require translation management to ensure that the mappings between virtual memory addresses and data stored in the caches is correct, even when a virtual memory system changes its mappings. In some examples, translation management for VIVT instruction caches by is accomplished by having software issue individual instruction cache invalidation instructions for each block in the instruction cache that needs to be invalidated.

Approaches described herein eliminate the need for software to issue individual instruction cache invalidation instructions for each block in the instruction cache by causing invalidation, in hardware, of all instruction memory blocks of a page associated with a virtual memory address when a translation lookaside buffer invalidation instruction for the virtual memory address is received. The approaches described herein essentially remove the burden from software to manage the instruction cache invalidation on a translation change. A physically-indexed and physically-tagged instruction cache would have the same effect. Consequently, the approaches described here make an instruction cache appear to software as a physically-indexed and physically-tagged instruction cache.

### 2 Computing System

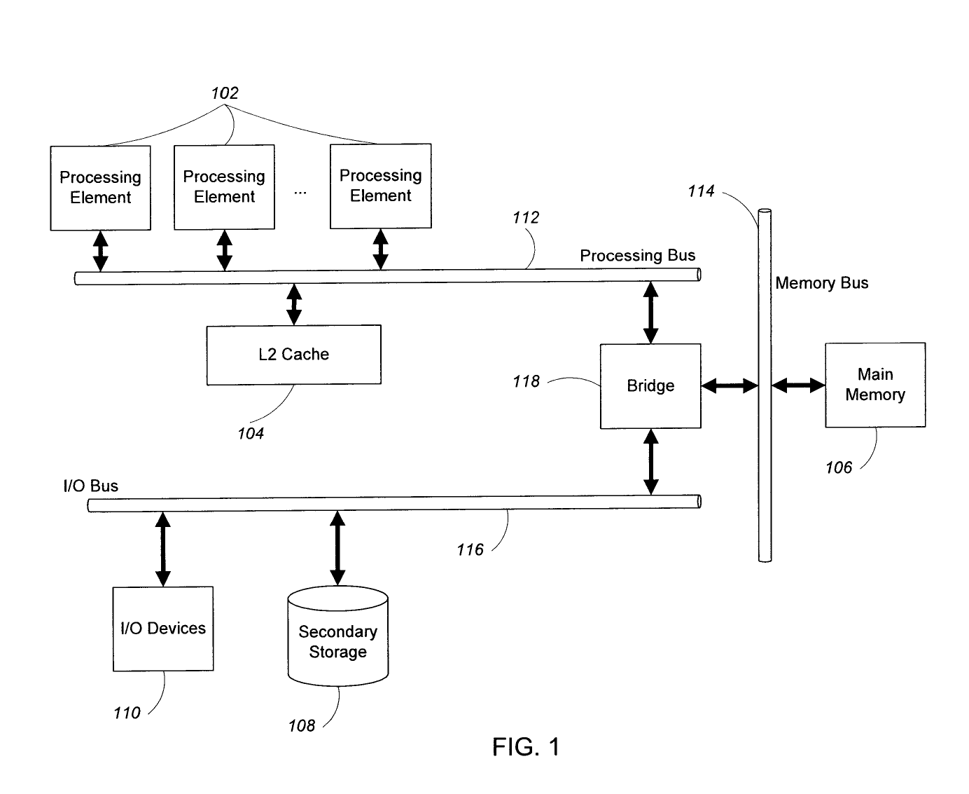

Referring to FIG. 1, a computing system 100 includes a number of processing elements 102, a level 2 (L2) cache 104 (e.g., SRAM), a main memory 106 (e.g., DRAM), a secondary storage device (e.g., a magnetic disk) 108, and one or more input/output (I/O) devices 110 (e.g., a keyboard or a mouse). The processing elements 102 and the L2 cache 104 are connected to a processor bus 112, the main memory 106 is connected to a memory bus 114, and the I/O devices 110 and the secondary storage device 108 are connected to an I/O bus 116. The processor bus 112, the memory bus 114, and the I/O bus 116 are connected to one another via a bridge 118.

### 2.1 Memory Hierarchy

In general, the processing elements 102 execute instructions of one or more computer programs, including reading processor instructions and data from memory included in the computing system 100. As is well known in the art, the various memory or storage devices in the computing system 100 are organized into a memory hierarchy based on a relative latency of the memory or storage devices. One example of such a memory hierarchy has processor registers (not shown) at the top, followed by a level 1 (L1) cache (not shown), followed by the L2 cache 104, followed by the main memory 106, and finally followed by the secondary storage 108. When a given processing element 102 tries to access a memory address, each memory or storage device in the memory hierarchy is checked, in order from the top of the memory hierarchy down, to determine whether the data for the memory address is stored in the storage device or memory device.

For example, for a first processing element of the processing elements 102 to access a memory address for data stored only in the secondary storage device 108, the processing element first determines whether the memory address and data are stored in its L1 cache. Since the memory address and data are not stored in its L1 cache, a cache miss occurs, causing the processor to communicate with the L2 cache 140 via that processor bus 112 to determine whether the memory address and data are stored in the L2 cache 140. Since the memory address and data are not stored in the L2 cache, another cache miss occurs, causing the processor to communicate with the main memory 106 via the processor bus 112, bridge 110, and memory bus 118 to determine whether the memory address and data are stored in the main memory 106. Since the memory address and data are not stored in the main memory 106, another miss occurs (also called a “page fault”), causing the processor to communicate with the secondary storage device 108 via the processor bus, the bridge 118, and the I/O bus 116 to determine whether the memory address and data are stored in the secondary storage device 108. Since the memory address and data are stored in the secondary storage device 108, the data is retrieved from the secondary storage device 108 and is returned to the processing element via the I/O bus 116, the bridge 118, and the processor bus 112. The memory address and data maybe cached in any number of the memory or storage devices in the memory hierarchy such that it can be accessed more readily in the future.

### 2.2 Processing Elements

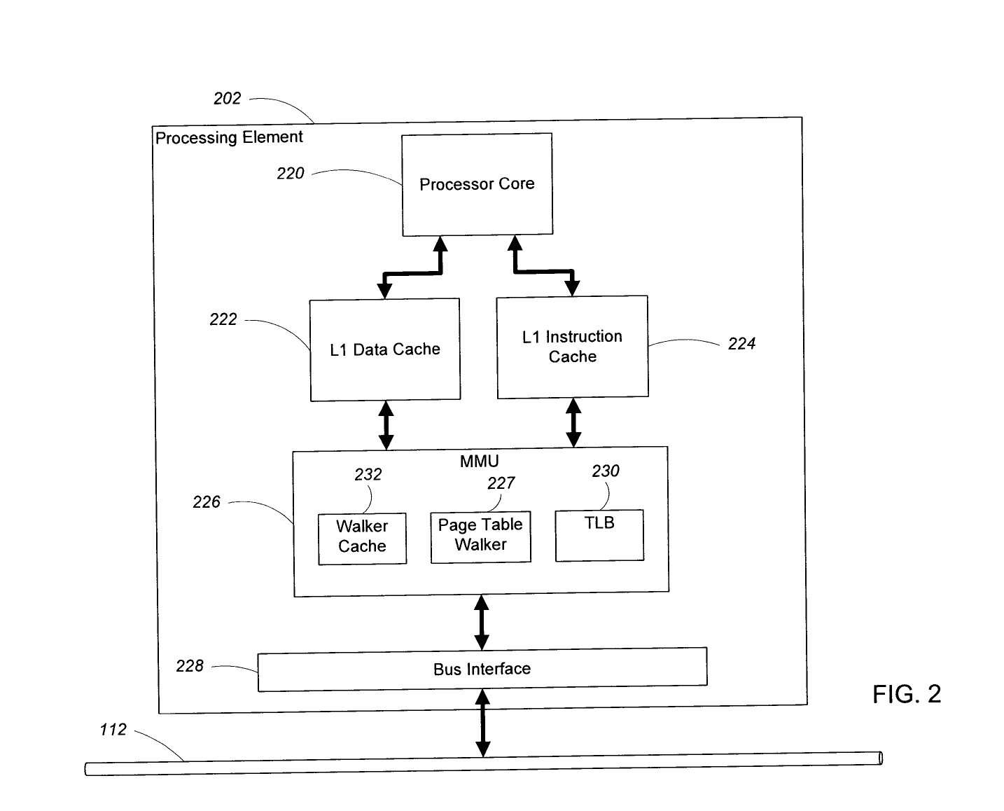

Referring to FIG. 2, one example of a processing element 202 of the processing elements 102 of FIG. 1 is connected to the processor bus 112. The processing element 202 includes a processor core 220, an L1 data cache 222, an L1 instruction cache 224, a memory management unit (MMU) 226, and a bus interface 228. The processor core 220 (also called simply a “core”) is an individual processor (also called a central processing unit (CPU)) that, together with other processor cores, coordinate to form a multi-core processor. The MMU 226 includes a page table walker 227, a translation lookaside buffer (TLB) 230, and a walker cache 232, each of which is described in more detail below.

Very generally, the processor core 220 executes instructions which, in some cases, require access to memory addresses in the memory hierarchy of the computing system 100. The instructions executed by the processing element 202 of FIG. 2 use virtual memory addresses. A variety of other configurations of the memory hierarchy are possible. For example, the TLB 230 could be located outside of each processing element, or there could be one or more shared TLBs that are shared by multiple cores.

### 2.2.1 Data Memory Access

When the processor core 220 requires access to a virtual memory address associated with data, the processor core 220 sends a memory access request for the virtual memory address to the L1 data cache 222. The L1 data cache 222 stores a limited number of recently or commonly used data values tagged by their virtual memory addresses. If the L1 data cache 222 has an entry for the virtual memory address (i.e., a cache hit), the data associated with the virtual memory address is returned to the processor core 220 without requiring any further memory access operations in the memory hierarchy. Alternatively, in some implementations, the L1 data cache 222 tags entries by their physical memory addresses, which requires address translation even for cache hits.

If the L1 data cache 222 does not have an entry for the virtual memory address (i.e., a cache miss), the memory access request is sent to the MMU 226. In general, the MMU 226 uses the TLB 230 to translate the virtual memory address to a corresponding physical memory address and sends a memory access request for the physical memory address out of the processor 202 to other elements of the memory hierarchy via the bus interface 228. The page table walker 227 handles retrieval of mappings that are not stored in the TLB 230, by accessing the full page table that is stored (potentially hierarchically) in one or more levels of memory. The page table walker 227 could be a hardware element as shown in this example, or in other examples the page table walker could be implemented in software without requiring a dedicated circuit in the MMU. The page table stores a complete set of mappings between virtual memory addresses and physical memory addresses that the page table walker 227 accesses to translate the virtual memory address to a corresponding physical memory address.

To speed up the process of translating the virtual memory address to the physical memory address, the TLB 230 includes a number of recently or commonly used mappings between virtual memory addresses and physical memory addresses. If the TLB 230 has a mapping for the virtual memory address, a memory access request for the physical memory address associated with the virtual memory address (as determined from the mapping stored in the TLB 230) is sent out of the processor 202 via the bus interface 228.

If the TLB 230 does not have a mapping for the for the virtual memory address (i.e., a TLB miss), the page table walker 227 traverses (or “walks”) the levels of the page table to determine the physical memory address associated with the virtual memory address, and a memory request for the physical memory address (as determined from the mapping stored in the page table) is sent out of the processor 202 via the bus interface 228.

In some examples, the TLB 230 and the page table are accessed in parallel to ensure that no additional time penalty is incurred when a TLB miss occurs.

Since the L1 data cache 222 and the TLB 230 can only store limited number of entries, cache management algorithms are required to ensure that the entries stored in the L1 data cache 222 and the TLB 230 are those that are likely to be re-used multiple times. Such algorithms evict and replace entries stored in the L1 data cache 222 and the TLB 230 based on a criteria such as a least recently used criteria.

### 2.2.2 Instruction Memory Access

When the processor core 220 requires access to a virtual memory address associated with processor instructions, the processor core 220 sends a memory access request for the virtual memory address to the L1 instruction cache 224. The L1 instruction cache 224 stores a limited number of processor instructions tagged by their virtual memory addresses. In some examples, entries in the L1 instruction cache 224 are also tagged with context information such as a virtual machine identifier, an exception level, or a process identifier. If the L1 instruction cache 224 has an entry for the virtual memory address (i.e., a cache hit), the processor instruction associated with the virtual memory address is returned to the processor core 220 without requiring any further memory access operations in the memory hierarchy. Alternatively, in some implementations, the L1 instruction cache 224 tags entries by their physical memory addresses, which requires address translation even for cache hits.

However, if the L1 instruction cache 224 does not have an entry for the virtual memory address (i.e., a cache miss), the memory access request is sent to the MMU 226. In general, the MMU 226 uses the instruction TLB to translate the virtual memory address to a corresponding physical memory address and sends a memory access request for the physical memory address out of the processor 202 to other elements of the memory hierarchy via the bus interface 228. As is noted above, this translation is accomplished using the page table walker 227, which handles retrieval of mappings between virtual memory addresses and physical memory addresses from the page table.

To speed up the process of translating the virtual memory address to the physical memory address, the TLB 230 includes a number of recently or commonly used mappings between virtual memory addresses and physical memory addresses. If the TLB 230 has a mapping for the virtual memory address, a memory access request for the physical memory address associated with the virtual memory address (as determined from the mapping stored in the TLB 230) is sent out of the processor 202 via the bus interface 228.

If the TLB 230 does not have a mapping for the for the virtual memory address (i.e., a TLB miss), the page table walker 227 walks the page table to determine the physical memory address associated with the virtual memory address, and a memory request for the physical memory address (as determined from the mapping stored in the page table) is sent out of the processor 202 via the bus interface 228.

In some examples, the TLB 230 and the page table are accessed in parallel to ensure that no additional time penalty is incurred when a TLB miss occurs.

Since the L1 instruction cache 224 and the TLB 230 can only store a limited number of entries, cache management algorithms are required to ensure that the mappings stored in the L1 instruction cache 224 and the TLB 230 are those that are likely to be re-used multiple times. Such algorithms evict and replace mappings stored in the L1 instruction cache 224 and the TLB 230 based on a criteria such as a least recently used criteria.

### 2.2.3 L1 Instruction Cache

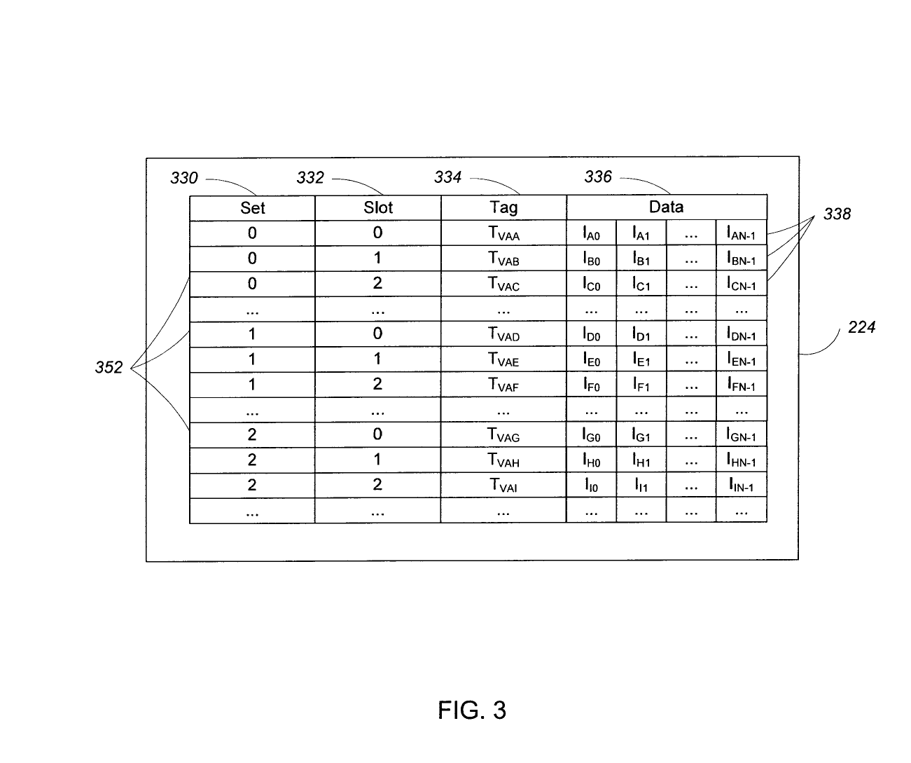

Referring to FIG. 3, in some examples, the L1 instruction cache 224 is implemented as a virtually indexed, virtually tagged (VIVT) set associative cache. In a VIVT set associative cache, the cache includes a number of sets 330, each set including a number of slots 332. In some examples, each slot 332 is associated with a cache line. Each of the slots includes a tag value 334 which includes some or all of a virtual memory address (e.g., a virtual page number) and instruction data 336 associated with the virtual memory address. The instruction data associated 336 with a given tag value 334 includes a number of blocks 338 including processor instructions.

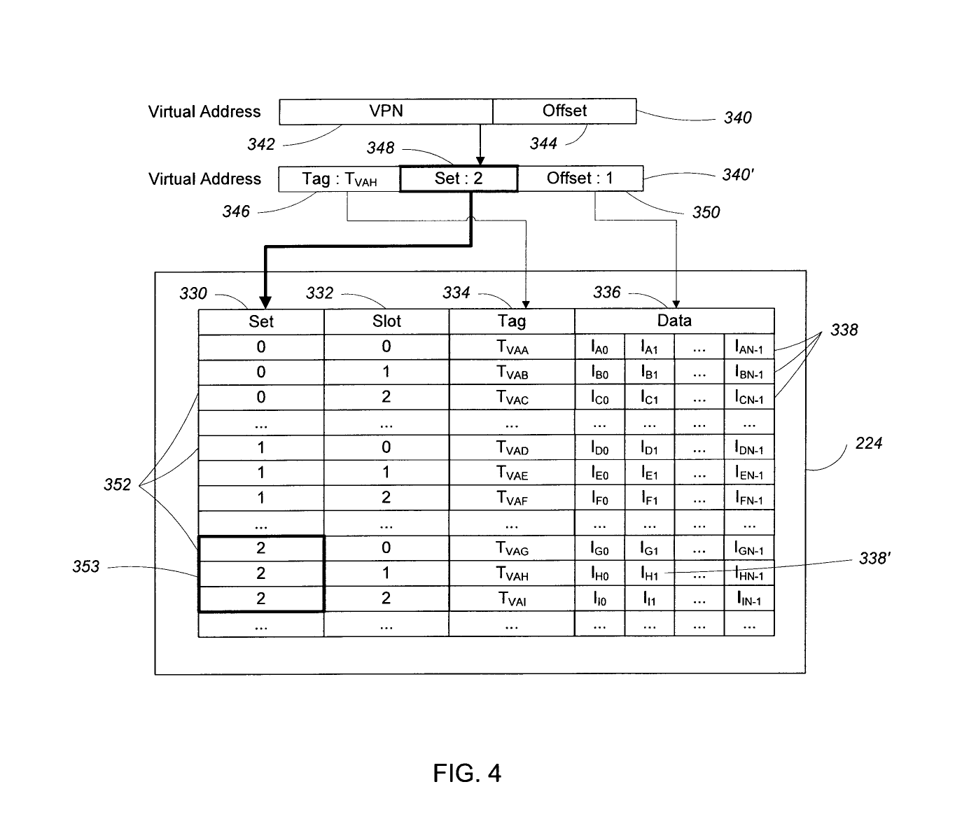

Referring to FIG. 4, to retrieve a processor instruction 338 from the L1 instruction cache 224, a virtual memory address 340 is provided to the L1 instruction cache 224. In some examples, the virtual memory address 340 includes a virtual page number (VPN) 342 and an offset 344. The L1 instruction cache 224 uses a different interpretation of the virtual memory address 340′. The different interpretation of the virtual memory address 340′ includes a tag value 346, a set value 348, and an offset value 350. In FIG. 4, the tag value 345 includes some or all of a virtual memory address denoted as H (VA_{H}), the set value 348 is ‘2’, and the offset value 350 is ‘1.’

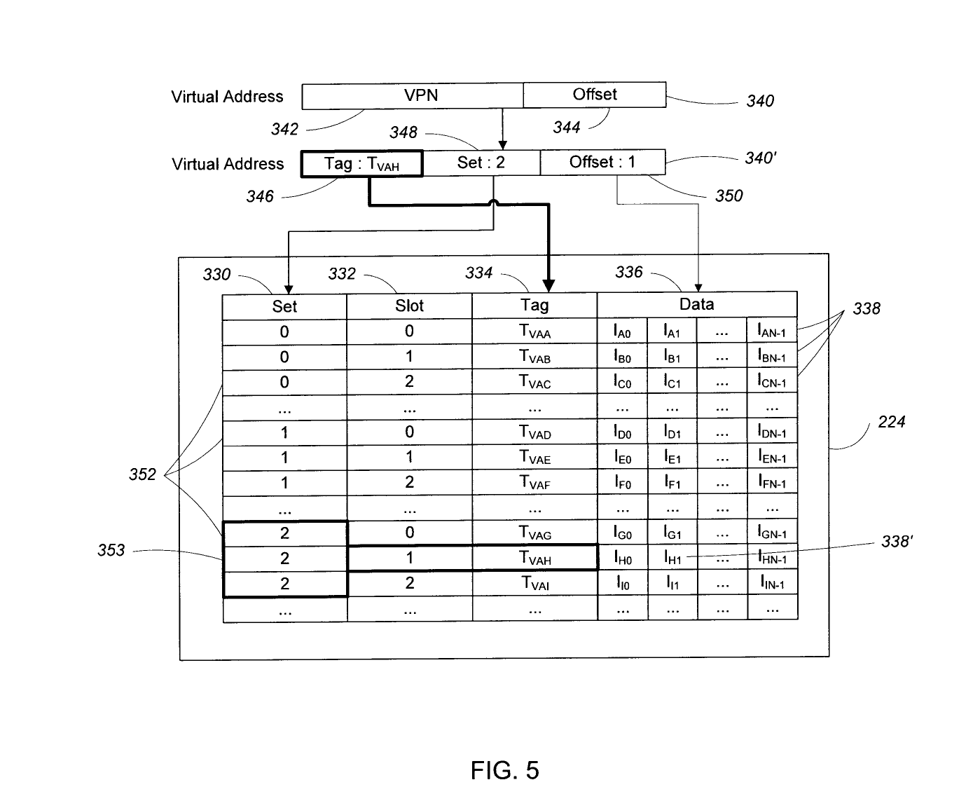

The first step in retrieving the processor instruction 338 includes identifying all cache lines 353 having a set value equal to ‘2.’ Referring to FIG. 5, the tags 334 of the cache lines 353 having a set value equal to ‘2’ are then compared to the tag value 346 of the virtual memory address 340′ to determine if any of the cache lines 352 having a set value equal to ‘2’ has a tag value of T_{VAH}. In this example, slot ‘1’ of set ‘2’ is identified as having a tag value of T_{VAH}.

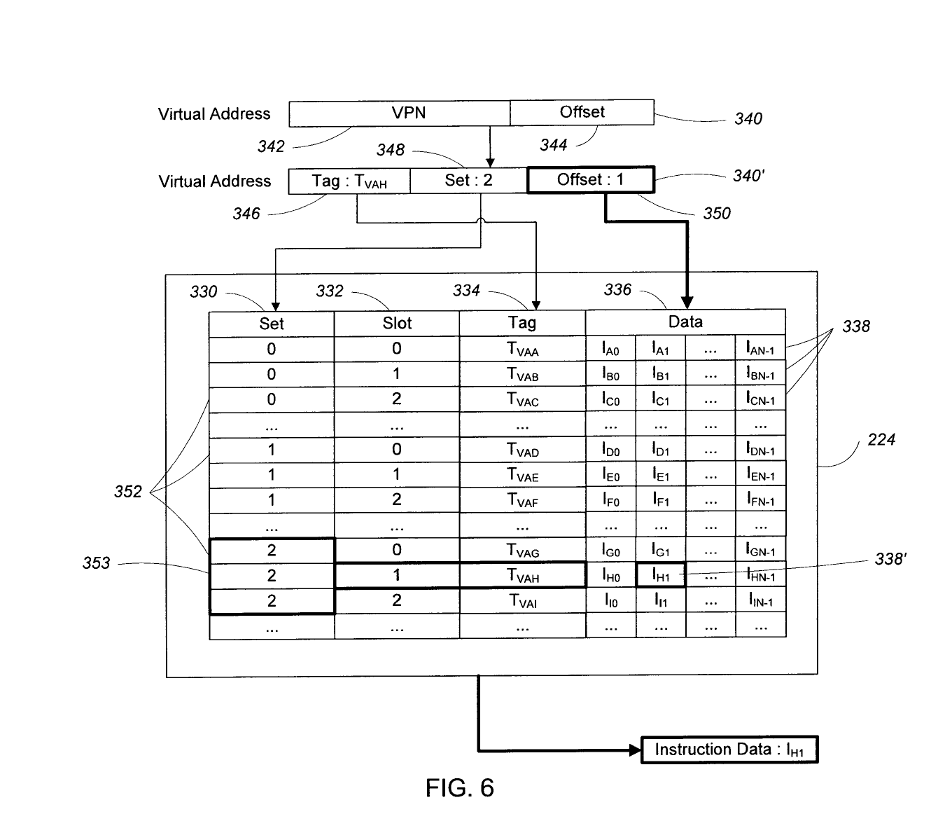

Referring to FIG. 6, with slot ‘1’ of set ‘2’ identified as having a tag value 334 matching the tag value 346 of the virtual memory address 340′, a cache hit has occurred. The offset value ‘1’ 350 of the virtual memory address 340′ is then used to access the processor instruction block, I_{H1} from the instruction data 336 associated with slot ‘1’ of set ‘2’ of the instruction cache 224, I_{H1} is output from the cache for use by the processor core 220.

Note that using a VIVT cache such as the instruction cache 224 can advantageously be accessed without requiring accessing the TLB 230. As such, lookups in VIVT caches require less time than lookups in some other types of caches such as virtually indexed, physically tagged (VIPT) caches.

### 2.2.4 TLB

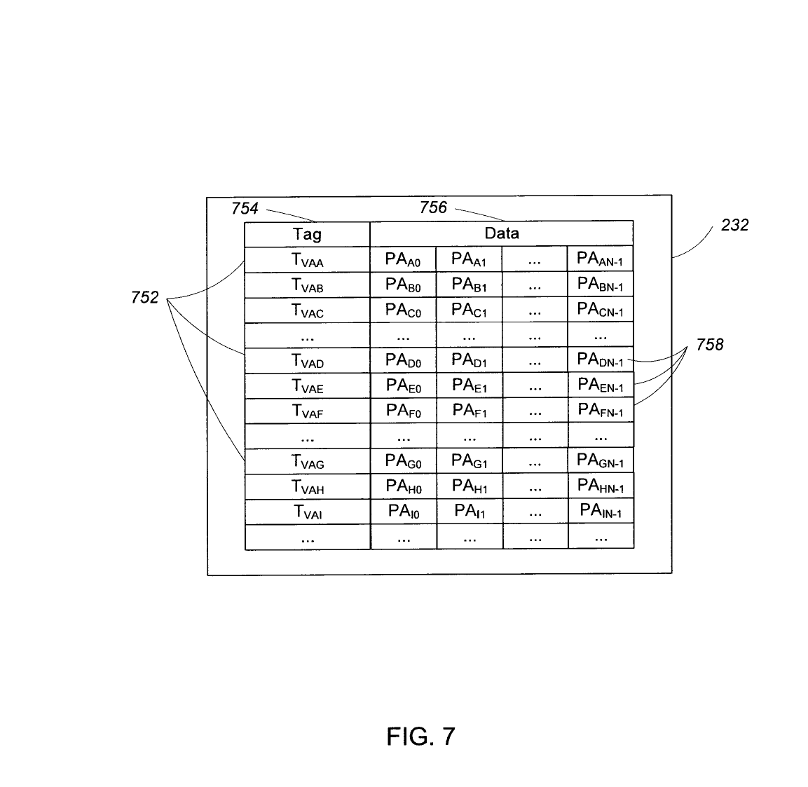

Referring to FIG. 7, in some examples, the TLB 230 is implemented as a fully associative, virtually indexed, virtually tagged (VIVT) cache. In a fully associated VIVT cache, the cache includes a number of cache lines 752, each including a tag value 754 and physical memory address data 756. In some examples, each cache line 752 in the TLB 230 is referred to as a ‘TLB entry.’ The tag value 754 includes some or all of a virtual memory address (e.g., a virtual page number) and the physical memory address data 756 includes one or more physical memory addresses 758 (e.g., a page of the page table 227 associated with the tag value.

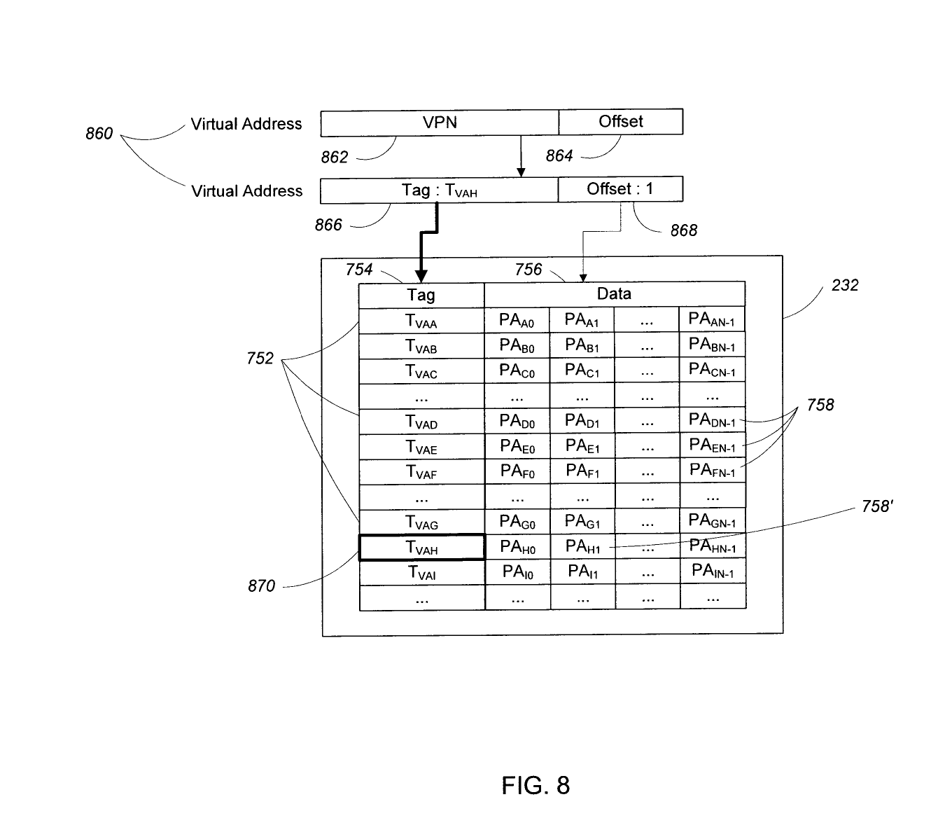

Referring to FIG. 8, to retrieve a physical memory address 758 for a given virtual memory address 860, the virtual memory address 860 is provided to the TLB 230. The virtual memory address 860 includes a virtual page number (VPN) 862 and an offset value 864. In some examples, the virtual memory address 860 can be interpreted as having a tag value 866 and an offset value 868. In FIG. 8, the tag value 866 includes some or all of a virtual memory address denoted as H (VA_{H}) and the offset value is ‘1.’

The first step in retrieving the physical memory address 758 includes comparing the tag values 754 of the cache lines 752 in the TLB 232 to determine if any of the cache lines 752 have a tag value 754 that is equal to the tag value 866 of the virtual memory address 860. In FIG. 8, a first cache line 870 is identified as having a tag value T_{VAH}, 754 matching the tag value T_{VAH} 866 of the virtual memory address 860.

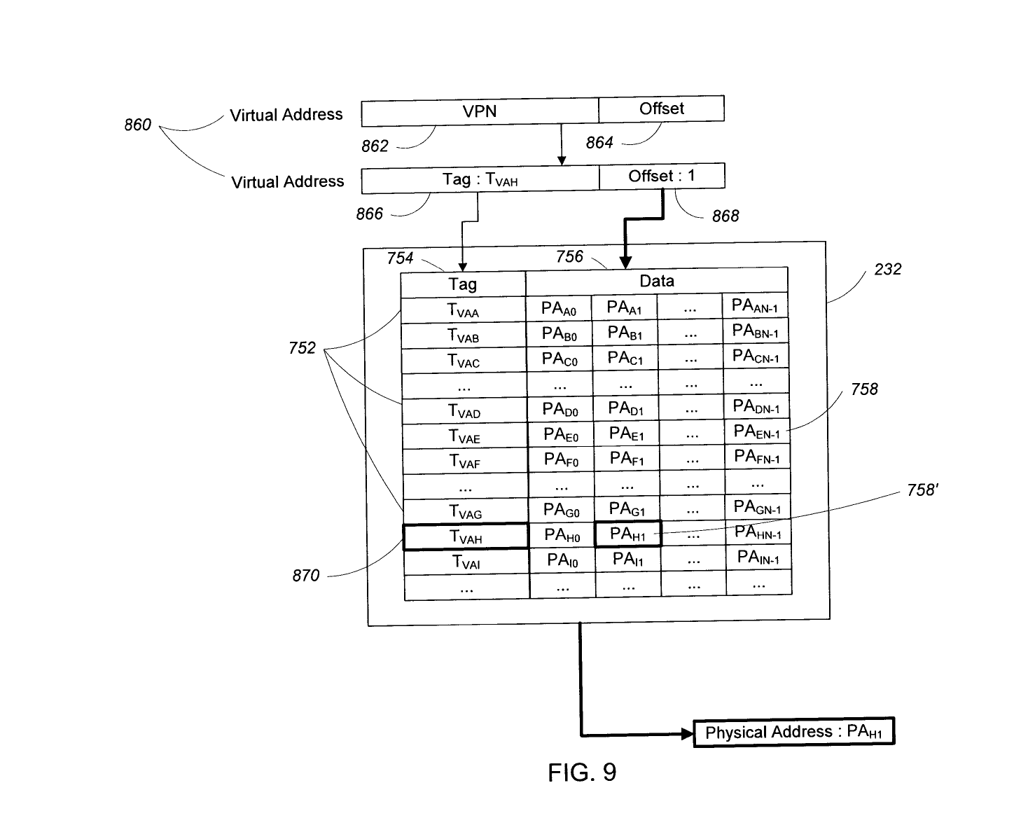

Referring to FIG. 9, the offset value 868 of the virtual memory address 860 is then used to access the physical memory address, PA_{H1} 758 at offset ‘1’ in the physical memory address data 756 of the first cache line 870. PA_{H1} is output from the TLB 230 for use other elements in the memory hierarchy.

### 2.3 Translation Lookaside Buffer Invalidation (TLBI) Instructions

In some examples, the computing system's virtual memory system may change its mappings between virtual memory addresses and physical memory addresses. In such cases, translation lookaside buffer invalidation instructions (TLBIs) for the virtual memory addresses are issued (e.g., by an operating system or by a hardware entity) to the TLB 230 in the computing system. In general, a TLBI instruction includes a virtual memory address and causes invalidation of any TLB entries associated with the virtual memory address. That is, when a TLB receives a TLBI for a given virtual memory address, any entries in the TLB storing mappings between the given virtual memory address and a physical memory address are invalidated.

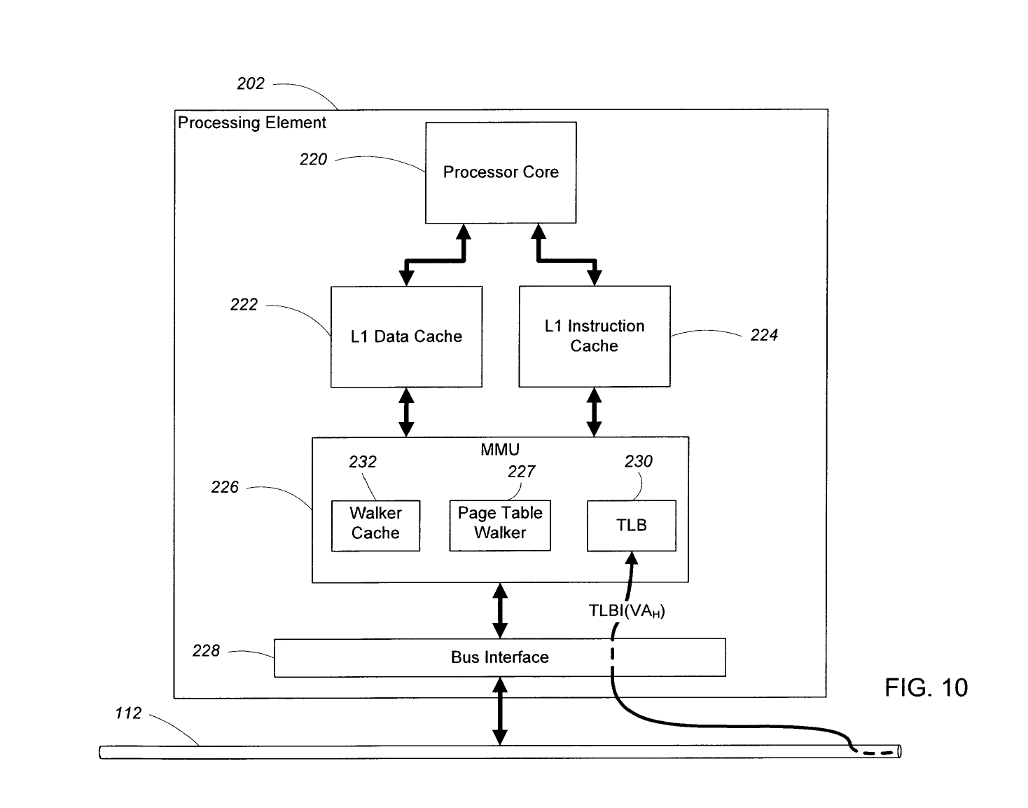

Referring to FIG. 10, when the processing element 202 receives a TLBI instruction for virtual memory address VA_{H} from the processing bus 112 at the bus interface 228, the bus interface 228 sends the TLBI instruction to the MMU 226. In this case, since the TLBI instruction is intended for the TLB 230, the TLBI instruction is provided to the TLB 230.

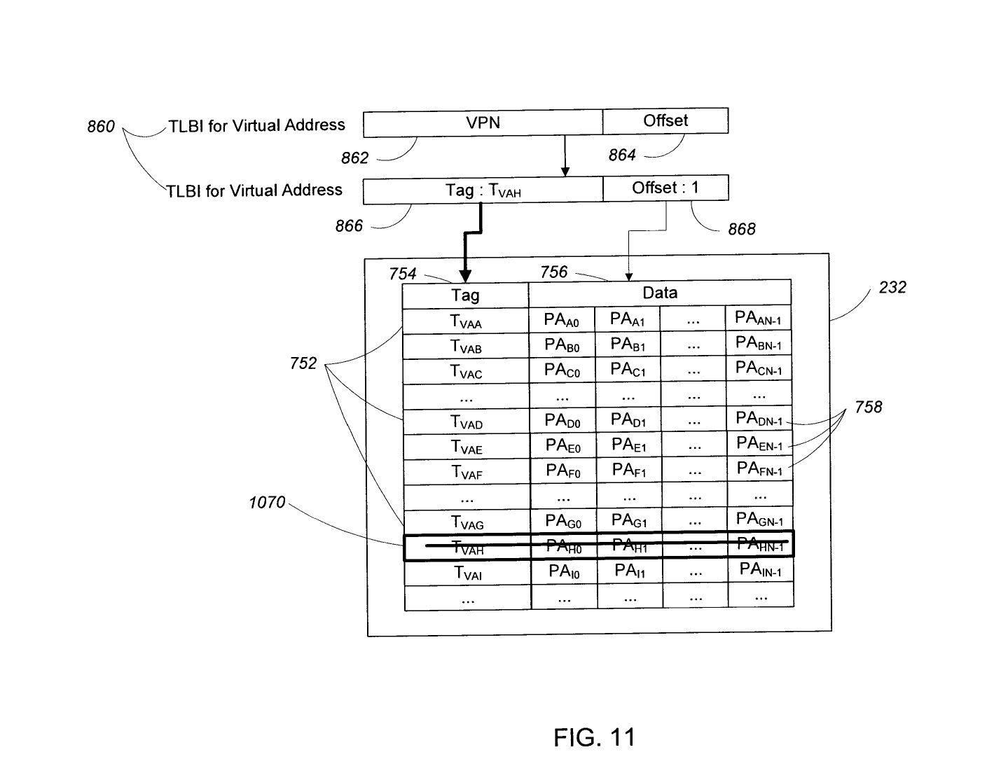

Referring to FIG. 11, when the TLBI instruction for the virtual memory address 860 is provided to the TLB 230, the TLB 230 searches the tag values 754 for each of the TLB entries 752 to determine if any of the TLB entries 752 has a tag value 754 matching the tag value 866 of the virtual memory address 860 of the TLBI instruction. In FIG. 10, a second TLBI entry 1070 is identified has having a tag value T_{VAH} matching the tag value, T_{VAH} of the virtual memory address 860 of the TLBI instruction. Once identified, the second TLBI entry 1070 is invalidated (e.g., by toggling an invalid bit in the entry).

### 2.4 Instruction Cache Invalidation

Since the L1 instruction cache 224 is a VIVT cache, any changes in translation between virtual memory addresses and physical memory addresses must also be managed in the L1 instruction cache 224. Some conventional processing elements with VIVT instruction caches manage changes in translation using software instructions that are independent of the TLBI instructions used to manage changes in translation for TLBs. In some examples, the software instructions for invalidating portions of the instruction cache only invalidate a single block of instruction data at a time. In some examples, it is undesirable or infeasible to use two separate software instructions to manage translation changes in the instruction cache and the instruction TLB.

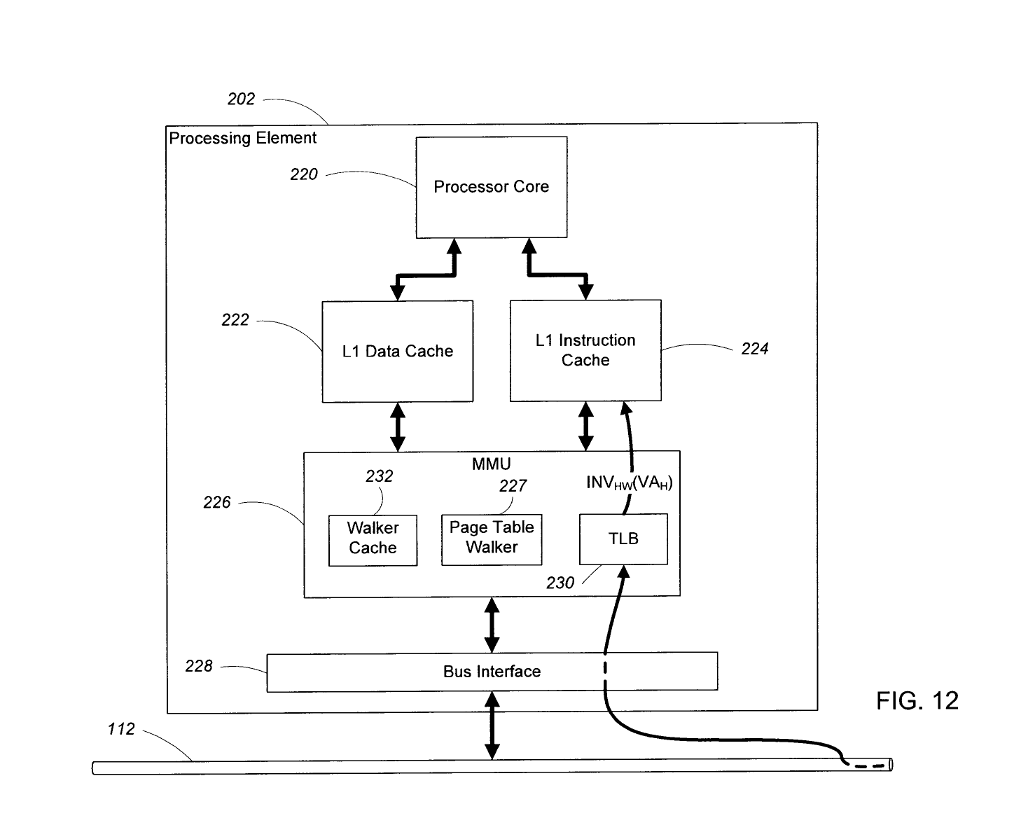

Referring to FIG. 12, when the processing element 202 receives a TLBI instruction for invalidating mappings associated with a virtual memory address in the TLB 230, the processing element 202 is configured to also cause invalidation of any cache lines associated with the virtual memory address in the L1 instruction cache 224.

In FIG. 12, in response to the TLBI instruction for the virtual memory address, V_{AH}, the MMU 227 causes a corresponding hardware based invalidation operation (INV_{HW}) to occur in the L1 instruction cache 224 for the virtual memory address VA_{H}. The INV_{HW}(VA_{H}) operation for the virtual memory address VA_{H} causes invalidation of any cache lines associated with the virtual memory address VA_{H} in the L1 instruction cache 224. In some examples, the instruction cache block size is significantly smaller than the TLB translation block size. Due to this size difference, in some examples, the TLBI instruction causes invalidation of multiple cache lines in the L1 instruction cache 224. In other examples, the TLBI instruction may cause invalidation of fewer instruction cache lines in the L1 instruction cache 224. For the sake of simplicity, the example below focuses on the latter case.

In some examples, the INV_{HW} instruction is generated and executed entirely in hardware without requiring execution of any additional software instructions by the processing element 202.

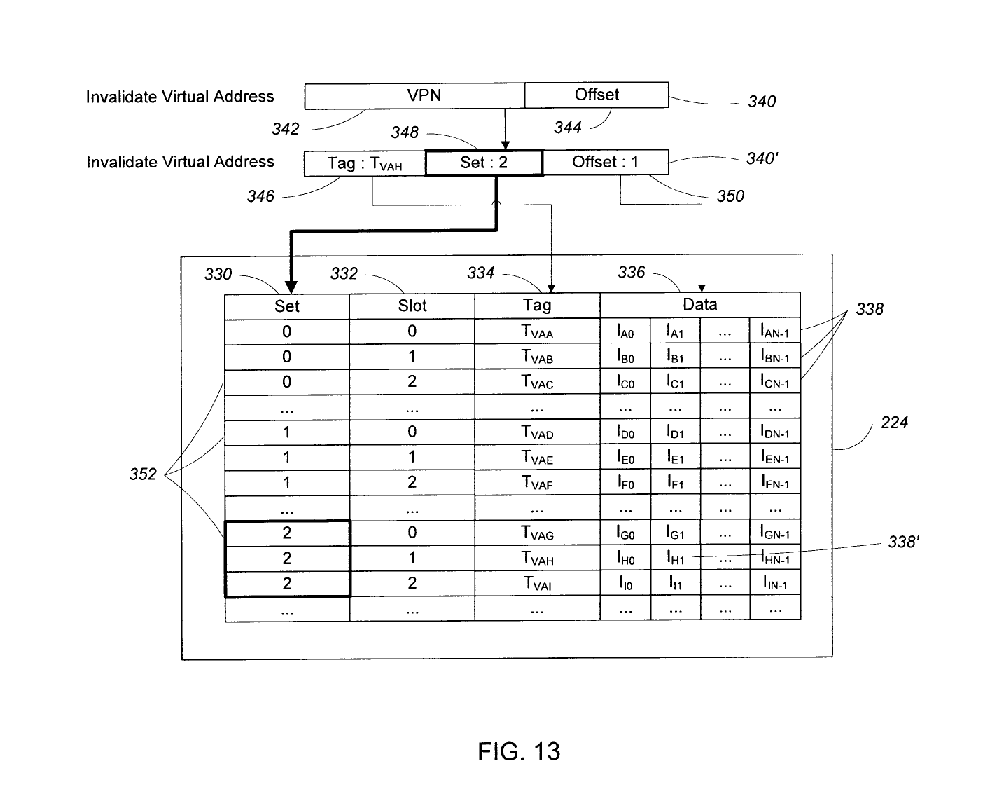

Referring to FIG. 13, when the INV_{HW}(VA_{H}) operation is executed at the L1 instruction cache 224, the L1 instruction cache 224 identifies all cache lines 352 having a set value 330 equal to the set value, ‘2’ 348 of the virtual memory address 340′ of the INV_{HW} instruction. Referring to FIG. 13, the tags values 334 of the cache lines 352 having a set value equal to ‘2’ are then compared to the tag value 346 of the virtual memory address 340′ to determine if any of the cache lines 352 having a set value equal to ‘2’ has a tag value of T_{VAH}. In this example, slot ‘1’ of set ‘2’ is identified as having a tag value of T_{VAH}. Once identified, the entire cache line located at slot ‘1’ of set ‘2’ is invalidated.

### 3 Alternatives

In some examples, other types of events related to translation changes can cause invalidation of entries in the L1 instruction cache of the processing element. For example, when a translation table is switched from an off position to an on position, or is switched from an on position to an off position, entries in the L1 instruction cache are invalided. When a base address of a page table entry register changes, entries in the L1 cache are invalidated. When registers that control the settings of the translation table change, entries in the L1 cache are invalidated.

In some examples, only a portion (e.g., a virtual page number) of the virtual memory address included with a TLBI instruction is used by the INV_{HW} instruction cache invalidation operation. In some examples, the portion of the virtual memory address is determined by a bit shifting operation.

In some examples, the entire virtual memory address included with a TLBI instruction is used by the INV_{HW} instruction cache invalidation operation to invalidate a single block of an entry in the instruction cache.

In the above approaches, the L1 data cache is described as being virtually tagged. However, in some examples, the L1 data cache is physically tagged, or both virtually and physically tagged.

Other embodiments are within the scope of the following claims.

What is claimed is:

1. A method for managing an instruction cache of a processing element, the instruction cache including a plurality of instruction cache entries, each entry including a mapping of a virtual memory address to one or more processor instructions, the method comprising:
issuing, at the processing element, a translation lookaside buffer invalidation instruction for invalidating a translation lookaside buffer entry in a translation lookaside buffer, the translation lookaside buffer entry including a mapping from a range of virtual memory addresses to a range of physical memory addresses;
causing invalidation of one or more of the instruction cache entries of the plurality of instruction cache entries in response to the translation lookaside buffer invalidation instruction.

2. The method of claim 1 further comprising determining the one or more instruction cache entries of the plurality of instruction cache entries including identifying instruction cache entries that include a mapping having a virtual memory address in the range of virtual memory addresses, wherein causing invalidation of one or more of the instruction cache entries includes invalidating each instruction cache entry of the one or more instruction cache entries.

3. The method of claim 2 wherein each instruction cache entry includes a virtual address tag and determining the one or more instruction cache entries includes, for each instruction cache entry of the plurality of instruction cache entries, comparing the virtual address tag of the instruction cache entry to the range of virtual memory addresses.

4. The method of claim 3 wherein comparing the virtual address tag of the instruction cache entry to the range of virtual memory addresses includes comparing the virtual address tag of the instruction cache entry to a portion of virtual memory addresses in the range of virtual memory addresses.

5. The method of claim 3 wherein the portion of the virtual memory addresses includes a virtual page number of the virtual memory addresses.

6. The method of claim 1 wherein causing invalidation of one or more of the instruction cache entries includes causing, at the processing element, an instruction cache entry invalidation operation.

7. The method of claim 6 wherein the instruction cache entry invalidation operation is a hardware triggered operation.

8. The method of claim 1 wherein the translation lookaside buffer invalidation instruction is a software triggered instruction.

9. The method of claim 1 wherein causing invalidation of one or more of the instruction cache entries includes causing invalidation of an entirety of each of the one or more instruction cache entries.

10. The method of claim 9 wherein causing invalidation of one or more of the instruction cache entries includes causing invalidation of all processor instructions associated with the one or more instruction cache entries.

11. The method of claim 1 wherein causing invalidation of one or more of the instruction cache entries includes causing invalidation of a single processor instruction associated with the one or more instruction cache entries.

12. The method of claim 1 wherein causing invalidation of one or more of the instruction cache entries includes causing invalidation of all of the instruction cache entries of the plurality of instruction cache entries.

13. An apparatus comprising:
at least one processing element, including:
an instruction cache including a plurality of instruction cache entries, each entry including a mapping of a virtual memory address to one or more processor instructions, and
a translation lookaside buffer including a plurality of translation lookaside buffer entries, each entry including a mapping from a range of virtual memory addresses to a range of physical memory addresses;
wherein the processing element is configured to issue a translation lookaside buffer invalidation instruction for invalidating a translation lookaside buffer entry in the translation lookaside buffer; and
wherein the processing element is configured to cause invalidation of one or more of the instruction cache entries of the plurality of instruction cache entries in response to the translation lookaside buffer invalidation instruction.

14. The apparatus of claim 13 wherein the processing element is configured to determine the one or more instruction cache entries of the plurality of instruction cache entries including identifying instruction cache entries that include a mapping having a virtual memory address in the range of virtual memory addresses, wherein causing invalidation of one or more of the instruction cache entries includes invalidating each instruction cache entry of the one or more instruction cache entries.

15. The apparatus of claim 14 wherein each instruction cache entry includes a virtual address tag and determining the one or more instruction cache entries includes, for each instruction cache entry of the plurality of instruction cache entries, comparing the virtual address tag of the instruction cache entry to the range of virtual memory addresses.

16. The apparatus of claim 15 wherein comparing the virtual address tag of the instruction cache entry to the range of virtual memory addresses includes comparing the virtual address tag of the instruction cache entry to a portion of virtual memory addresses in the range of virtual memory addresses.

17. The apparatus of claim 15 wherein the portion of the virtual memory addresses includes a virtual page number of the virtual memory addresses.

18. The apparatus of claim 13 wherein causing invalidation of one or more of the instruction cache entries includes causing, at the processing element, an instruction cache entry invalidation operation.

19. The apparatus of claim 18 wherein the instruction cache entry invalidation operation is a hardware triggered operation.

20. The apparatus of claim 13 wherein the translation lookaside buffer invalidation instruction is a software triggered instruction.

21. The apparatus of claim 13 wherein causing invalidation of one or more of the instruction cache entries includes causing invalidation of an entirety of each of the one or more instruction cache entries.

22. The apparatus of claim 21 wherein causing invalidation of one or more of the instruction cache entries includes causing invalidation of all processor instructions associated with the one or more instruction cache entries.

23. The apparatus of claim 13 wherein causing invalidation of one or more of the instruction cache entries includes causing invalidation of a single processor instruction associated with the one or more instruction cache entries.

24. The apparatus of claim 13 wherein causing invalidation of one or more of the instruction cache entries includes causing invalidation of all of the instruction cache entries of the plurality of instruction cache entries.
